(19) United States
(12) Patent Application Publication
(10) Pub. No.: US 2012/0217227 A1
(43) Pub. Date: Aug. 30, 2012

(54) METHOD OF INTRODUCING COMPRESSIVE STRESS IN A WELDED JOINT

(75) Inventor: Jin Xu, Shenyang (CN)

(73) Assignee: GENERAL ELECTRIC COMPANY, Schenectady, NY (US)

(21) Appl. No.: 13/036,357

(22) Filed: Feb. 28, 2011

(51) Int. Cl. B23K 11/00

(52) U.S. Cl. 219/117.1

(57) ABSTRACT

A method of introducing compressive stress in a weld joint having at least one weld toe is provided. The method includes the step of covering the weld toe of the welded joint with a resistance wire. The method also includes the step of heating the weld toe by the resistance wire, where the weld toe is heated to a selected temperature. The method includes the step of maintaining the weld toe at the selected temperature for a selected amount of time. The method includes the step of removing the resistance wire from the weld toe. The method includes the step of quenching the weld toe with a cooling medium. Compressive stress is introduced to the weld toe during quenching.

### BACKGROUND OF THE INVENTION

The subject matter disclosed herein relates to a method of introducing compressive stress in a welded joint, and particularly to a method of introducing compressive stress in a weld toe of the welded joint.

Fatigue is a common failure mode for welded joints. Cracks in the welded joint tend to emanate from the weld toe of the welded joint. The weld toe is the region on the surface of the weld joint at the transition point between the weld metal and the base metal. The weld toe has high stress concentrations as well as residual stress that both contribute to the high occurrence of fatigue. One example of fatigue occurs in a welded joint that joins the pipe with the fuel nozzle flange of a gas turbine. In one example, 304 stainless steel may be used for the pipe and fuel nozzle flange. High frequency vibration may be generated as the feeding mode of the fuel is changed during operation of the gas turbine, which may lead to recycling stress on the pipe and fuel nozzle. Moreover, the weld joint is also subjected to vibration from operation of the gas turbine as well. Constant exposure to thermal shock and vibration may contribute to the occurrence of fatigue of the welded joint.

Several approaches currently exist for increasing the fatigue strength and durability of a welded joint, however all these approaches each have drawbacks. For example, in one approach shot peening is performed on the welded joint to improve fatigue strength. However, shot peening can be difficult to perform on smaller welded joints or on certain areas of the turbine. In another approach, welding process parameters such as welding current, arc voltage, weld speed, or wire diameter or elongation could be adjusted to improve the weld. However, sometimes some of the welding process parameters can not be adjusted for various reasons. In another approach, the entire assembly, such as the entire fuel nozzle and the fuel nozzle flange could be placed in an oven for annealing. However, annealing the entire fuel nozzle assembly can be costly. Accordingly, a need exists for a cost effective process that reduces the possibility of failure in a welded joint by fatigue.

### BRIEF DESCRIPTION OF THE INVENTION

According to one aspect of the invention, a method of introducing compressive stress in a weld joint having at least one weld toe is provided. The method includes the step of covering the weld toe of the welded joint with a resistance wire. The method also includes the step of heating the weld toe by the resistance wire, where the weld toe is heated to a selected temperature. The method includes the step of maintaining the weld toe at the selected temperature for a selected amount of time. The method includes the step of removing the resistance wire from the weld toe. The method includes the step of quenching the weld toe with a cooling medium. Compressive stress is introduced to the weld toe during quenching.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an exemplary illustration of a welded joint joining a fuel nozzle and a flange;

FIG. 2 is an illustration of the welded joint in FIG. 1 covered by resistance wire at a weld toe; and

FIG. 3 is a flow diagram illustrating a method of introducing compressive stress at the weld toe.

The detailed description explains embodiments of the invention, together with advantages and features, by way of example with reference to the drawings.

### DETAILED DESCRIPTION OF THE INVENTION

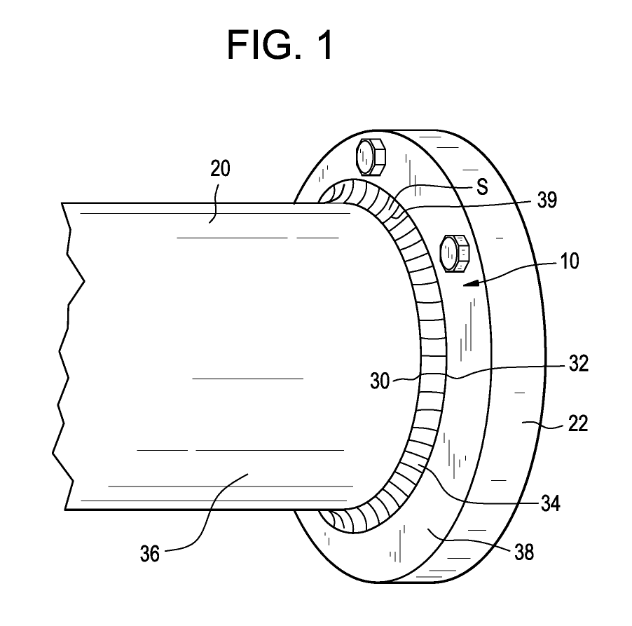

FIG. 1 is an exemplary illustration of a welded joint 10. In the exemplary embodiment as shown, the welded joint 10 joins a pipe 20 and a flange 22 together, where the 20 and the flange 22 are part of a gas turbine assembly (not shown). It should be noted that while FIG. 1 illustrates the welded joint 10 joining a nozzle and flange of a turbine together, the welded joint 10 could be employed in different applications as well. The welded joint 10 includes two weld toes 30 and 32. The weld toes 30, 32 represent the region of the weld joint 10 between a weld metal 34 of the welded joint 10 and a base metal. Specifically, the weld toe 30 represents the region of the weld joint 10 between the weld metal 34 and a base metal 36 of the pipe 20. The weld toe 32 represents the region of the weld joint 20 between the weld metal 34 and a base metal 38 of the flange 22. The welded joint 10 has an outer surface S that includes a series of raised protrusions 39 that are created during welding of the pipe 20 with the flange 22. In one embodiment, the pipe 20 and the flange 22 are welded together by arc welding, however it is understood that other types of welding processes may be used as well.

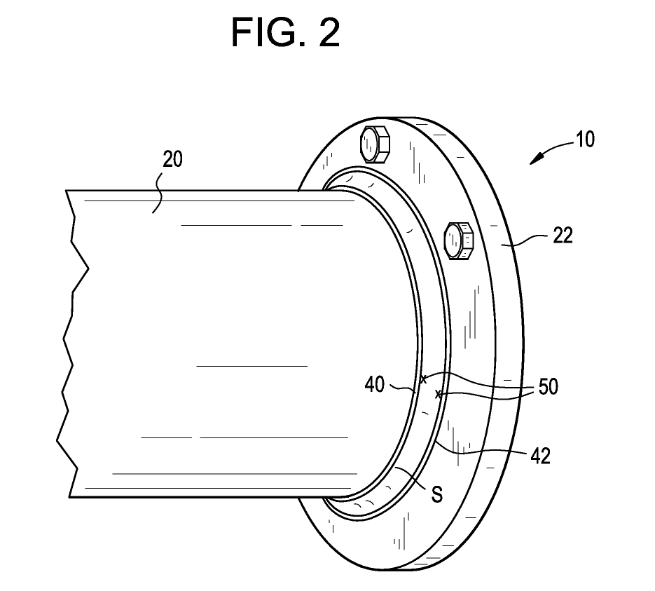

The weld toes 30, 32 are created by welding the pipe 20 and the flange 22 together. After creating the welded toes 30, 32 by a welding process such as arc welding, the weld toes 30, 32 are then heated to a selected temperature, and subsequently quenched by a cooling medium. Heating and quenching the weld toes 30, 32 introduces compressive stress to the weld toes 30, 32. Specifically, FIG. 2 is an illustration of the welded joint 10 being heated by resistance wires 40, 42. The weld toe 30 (shown in FIG. 1) is covered by a length of electrical resistance wire 40 and the weld toe 32 (shown in FIG. 1) is covered by a length of electrical resistance wire 42. The electrical resistance wires 40 and 42 are heating element wires that are connected to a power supply through a current control device (not shown). The electrical resistance wires 40, 42 are any type of resistance wires typically used for high-power resistors and heating elements. For example, the resistance wires 40, 42 may be constructed from a Nichrome® or a Kanthal alloy, however it is understood that the resistance wires 40, 42 could be constructed from other types of alloys as well.

A thermocouple 50 may also be placed adjacent to one or both of the resistance wires 40, 42 for monitoring the temperature of the weld toes 30 and 32. The thermocouples 50 are in communication with a data acquisition device (not shown), where a user monitors the temperature of the welded toes 30 and 32 through the data acquisition device. Monitoring the temperature of the welded toes 30, 32 ensures that the temperature of the weld toes 30, 32 do not exceed a selected temperature. The selected temperature represents a specific temperature range at which tensile stress is introduced to the welded joint 10. Specifically, referring to both of FIGS. 1-2, as the welded joint 10 is heated to the selected temperature, the weld toes 30, 32 thermally expand. The surrounding the base metal 36 of the pipe 20 and the base metal 38 of the flange 22 compress the welded toes 30, 32 as the welded toes 30, 32 thermally expand. Thus, the strain of the welded toes 30, 32 are restricted by the surrounding pipe 20 and flange 22. Therefore, as the weld toes 30, 32 expand, the elastic limit of the material of the welded joint 10 at the welded toes 30, 32 is exceeded. The weld toes 30, 32 are then maintained at the selected temperature for a selected amount of time. The welded joint 10 is then quenched or rapidly cooled by a cooling medium such as, for example, compressed air or atomized water. Compressed air is typically used for smaller welded joints, and atomized water is typically used for larger welded joints.

As the weld toes 30, 32 are cooled, the metal material located in the weld toes 30, 32 are shrunk which generates tensile strain. If the weld toe 30, 32 are cooled rapidly by quenching, the tensile strain located in the weld toes 30, 32 will be more than the compression strain induced during heating to the specified temperature. Accordingly, residual strain is generated in the weld toes 30, 32 as the weld toes 30, 32 are cooled to room temperature. The weld joint 10 is generally strain controlled, which results in the strain tending to be about zero at room temperature. Thus, residual compression stress will be generated in the weld toe 30, 32. It should be noted that the selected temperature should be high enough such that the elastic limit of the material of the welded joint 10 should be exceeded, leading to compression yield. Quenching the weld toes 30, 32 after heating allows the weld toes 30, 32 to normally cool without a cooling medium typically results in residual tensile stress instead of compression stress being introduced in the weld toes 30, 32, which in turn may actually reduce the fatigue life of the welded joint 10.

In one exemplary embodiment, the pipe 20 and the flange 22 are each constructed from a stainless steel alloy. In this embodiment, the selected temperature ranges from about 400° F. to about 500° F., which is the temperature needed to introduce compressive stress into the welded joint 10. The welded joint 10 is maintained at the selected temperature for the selected amount of time, which is about five to about ten minutes. Then, the welded joint 10 is quenched with a cooling medium to reach about room temperature. In one embodiment, the welded joint 10 is quenched. Although a stainless steel alloy is discussed, it is understood that the welded joint 10 may be constructed from other types of metal based materials as well. The selected temperature depends on the specific material that the welded joint 10 is constructed from, and may be adjusted accordingly to introduce compression stress being introduced in the welded joint 10.

Referring now to FIG. 2, the outer surface S of the welded joint 10 has been grounded to substantially remove the series of raised protrusions 39 such that the weld toes 30, 32 (shown in FIG. 1) have a generally smooth contour. Grinding the outer surface S tends to result in lower stress concentrations in the welded joint 10. In one exemplary embodiment, the outer surface S is ground by an angle grinder, however it is understood that other device may be used as well to grind the welded joint 10.

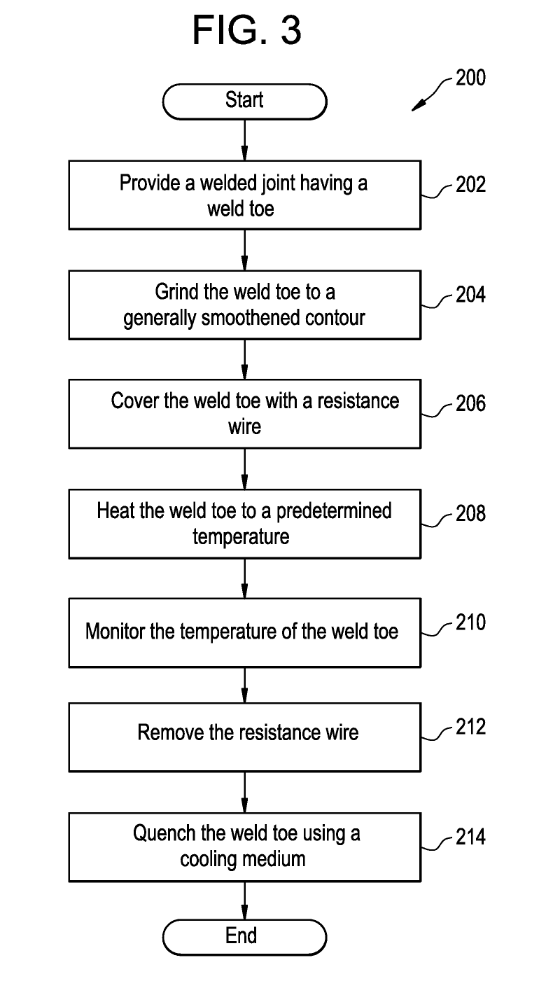

A method of introducing compressive stress in the welded joint 10 will now be discussed. FIG. 3 is a process flow diagram illustrating a method 200 of introducing compressive stress in a welded joint 10. The method 200 begins at step 202, where the welded joint 10 is provided. Referring back to FIG. 1, the welded joint 10 joins a pipe 20 and a flange 22 of a turbine assembly (not shown) together. The welded joint 10 includes two weld toes 30 and 32. The weld toe 30 represents the region of the weld joint 10 between the weld metal 34 and a base metal 36 of the pipe 20. The weld toe 32 represents the region of the weld joint 20 between the weld metal 34 and a base metal 38 of the flange 22. The welded joint 10 has an outer surface S that includes a series of raised protrusions 39 that are created during welding of the pipe 20 with the flange 22. Method 200 may then proceed to step 204.

In step 204, the outer surface S of the welded toes 30, 32 are ground to a generally smooth contour. Specifically, referring to FIG. 1, the series of raised protrusions 39 are substantially removed, thereby leaving a generally smooth outer surface S. Method 200 may then proceed to step 206.

In step 206, the weld toes 30 and 32 are covered with resistance wire 40 and 42. Referring to FIGS. 1-2, the weld toe 30 is covered by a length of electrical resistance wire 40 and the weld toe 32 is covered by a length of electrical resistance wire 42. The electrical resistance wires 40 and 42 are heating element wires that are connected to a power supply through a current control device (not shown). Method 200 may then proceed to step 208.

In step 208, the weld toes 30 and 32 are heated to a selected temperature. The selected temperature represents a specific temperature range at which tensile stress is introduced to the welded joint 10. In one exemplary embodiment, the pipe 20 and the flange 22 are each constructed from a stainless steel alloy, and the selected temperature ranges from about 400° F. to about 500° F. Method 200 may then proceed to step 210.

In step 210, the temperature of the welded toes 30, 32 is monitored by thermocouples 50. Referring back to FIG. 2, one or more thermocouples 50 are placed adjacent to one or both of the resistance wires 40, 42 for monitoring the temperature of the weld toes 30 and 32. The thermocouples 50 are in communication with a data acquisition device (not shown), where a user monitors the temperature of the welded toes 30 and 32 through the data acquisition device. Monitoring the temperature of the welded toes 30, 32 ensures that the temperature of the weld toes 30, 32 does not exceed the selected temperature. Method 200 may then proceed to step 212.

In step 212, the resistance wires 40 and 42 are removed from the welded toes 30 and 32. Method 200 may then proceed to step 214.

In step 214, the weld toes 30 and 32 are quenched by a cooling medium. The cooling medium is generally any type of medium used to quench or rapidly cool a metal based material. The welded joint 10 is quenched with a cooling medium to reach about room temperature. Quenching the welded joint 10 results in the welded toes 30, 32 being compressed by the surrounding area of the welded joint 10. Compressing the weld toes 30, 32 results in compression stress being induced in the welded toes 30, 32. Compression stress results in increased fatigue life of the welded toes 30, 32. Method 200 may then terminate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of introducing compressive stress in a weld joint having at least one weld toe, comprising:
covering the at least one weld toe of the welded joint with a resistance wire;
heating the at least one weld toe by the resistance wire, wherein the at least one weld toe is heated to a selected temperature;
maintaining the at least one weld toe at the selected temperature for a selected amount of time;
removing the resistance wire from the at least one weld toe; and
quenching the at least one weld toe with a cooling medium, whereby compressive stress is introduced to the at least one weld toe during quenching.

2. The method of claim 1, comprising grinding an outer surface of the welded joint to a generally smooth contour before covering the at least one weld toe with resistance wire.

3. The method of claim 1, comprising applying at least one of compressed air and atomized water as the cooling medium.

4. The method of claim 1, comprising monitoring a temperature of the at least one weld toe with a thermocouple, wherein the thermocouple is placed adjacent the at least one weld toe.

5. The method of claim 4, comprising determining if the selected temperature of the at least one weld toe has been exceeded.

6. The method of claim 1, wherein the selected temperature ranges from about 400° F. to about 500° F.

7. The method of claim 1, wherein the selected amount of time is about five to about ten minutes.

8. The method of claim 1, comprising cooling the welded toe to about room temperature.

9. The method of claim 1, wherein the welded joint is constructed from a stainless steel alloy.

10. A method of introducing compressive stress in a welded joint, the welded joint having at least one weld toe, and wherein the welded joint joins a nozzle and a flange of a turbine engine, comprising:
grinding an outer surface of the welded joint to a generally smooth contour;
covering the at least one weld toe of the welded joint with a resistance wire;
heating the at least one weld toe by the resistance wire, wherein the at least one weld toe is heated to a selected temperature;
maintaining the at least one weld toe at the selected temperature for a selected amount of time;
removing the resistance wire from the at least one weld toe; and
quenching the at least one weld toe with a cooling medium, whereby compressive stress is introduced to the at least one weld toe during quenching.

11. The method of claim 10, comprising applying at least one of compressed air and atomized water as the cooling medium.

12. The method of claim 10, comprising monitoring a temperature of the at least one weld toe with a thermocouple, wherein the thermocouple is placed adjacent the at least one weld toe.

13. The method of claim 12, comprising determining if the selected temperature of the at least one weld toe has been exceeded, wherein the thermocouple detects if the selected temperature has been exceeded.

14. The method of claim 12, wherein the selected temperature ranges from about 400° F. to about 500° F.

15. The method of claim 12, wherein the selected amount of time is about five to about ten minutes.

16. The method of claim 10, comprising cooling the welded toe to about room temperature.

17. The method of claim 10, wherein the welded joint is constructed from a stainless steel alloy.

18. A method of introducing compressive stress in a welded joint, the welded joint having at least one weld toe, and the welded joint joins a nozzle and a flange of a gas turbine engine, comprising:
grinding an outer surface of the welded joint to a generally smooth contour;
covering the at least one weld toe of the welded joint with a resistance wire;
heating the at least one weld toe by the resistance wire, wherein the at least one weld toe is heated to a selected temperature;
maintaining the at least one weld toe at the selected temperature for a selected amount of time;
monitoring a temperature of the at least one weld toe with a thermocouple, wherein the thermocouple is placed adjacent the at least one weld toe;
removing the resistance wire from the at least one weld toe; and
quenching the at least one weld toe with a cooling medium to room temperature, wherein compressive stress is introduced to the at least one weld toe during quenching.

19. The method of claim 18, comprising applying at least one of compressed air and atomized water as the cooling medium.

20. The method of claim 18, comprising determining if the selected temperature of the at least one weld toe has been exceeded, wherein the thermocouple detects if the selected temperature has been exceeded.
